(19) United States
(12) Patent Application Publication
(10) Pub. No.: US 2025/0110344 A1
(43) Pub. Date: Apr. 3, 2025

(54) BEAM SPLITTER, STACK COMPRISING TWO OR MORE SUCH BEAM SPLIT-TERS AND METHOD OF MANUFACTURING SUCH A BEAM SPLITTER

(71) Applicant: SCHOTT AG, Mainz (DE)

(72) Inventor: Frank WOLFF, Mainz (DE)

(73) Assignee: SCHOTT AG, Mainz (DE)

(21) Appl. No.: 18/898,942

(22) Filed: Sep. 27, 2024

(30) Foreign Application Priority Data
Sep. 29, 2023 (DE) 10 2023 126 654.3

(51) Int. Cl. G02B 27/10

(52) U.S. Cl. CPC G02B 27/1066; G02B 27/1073

(57) ABSTRACT

The present invention relates to a beam splitter and a method of manufacturing such a beam splitter. The present invention also relates to a stack comprising two or more such beam splitters.

### CROSS-REFERENCE TO RELATED APPLICATIONS

This application claims the benefit of priority from German Patent Application No. 10 2023 126 654.3, filed Sep. 29, 2023, the disclosure of which is incorporated herein by reference.

### FIELD OF THE INVENTION

The present invention relates to a beam splitter and a method of manufacturing such a beam splitter. The present invention also relates to a stack comprising two or more such beam splitters.

### BACKGROUND OF THE INVENTION

In reflective augmented reality waveguides, light from a projector coupled into the waveguide is internally directed, modified, or reflected out of the waveguide and into a user's eye by means of one or more beam splitters. However, with conventional waveguides, the quality of the image presented to the user is often less than optimal due to low contrast, insufficient color fidelity and reduced sharpness.

It is, thus, an object of the present invention to overcome the disadvantages described above and to provide means to improve the quality of the respective images presented to the user.

### SUMMARY OF THE INVENTION

The problem is solved by the invention according to a first aspect in that a beam splitter is proposed.

The problem is in particular solved by a beam splitter comprising a substrate made of a substrate material and at least one coating arranged on at least one main surface of the substrate, wherein along a first direction which is parallel to the normal vector of the main surface, the substrate and all coatings have a total thickness, and
wherein for a specific light beam having a specific chromaticity defined by CIE x and y,
which is incident on the beam splitter along a second direction with at least one incident angle in the range from 15° to 75°, preferably in the range from 15° to 45°, preferably in the range from 20 to 42°, particularly preferably with an angle of 32° enclosed between a vector pointing in said first direction and a vector pointing in said second direction,
and which is partly transmitted through the beam splitter and partly reflected by the beam splitter,
said light beam after transmitting through the beam splitter has a difference between the CIE x coordinates of the specific light beam and the CIE x coordinates of the light beam after transmitting through the beam splitter is less than 0.05, preferably less than 0.025, and more preferably less than 0.005 and/or
a difference between the CIE y coordinates of the specific light beam and the CIE y coordinates of the light beam after transmitting through the beam splitter is less than 0.05, preferably less than 0.025 and more preferably less than 0.005.

It is, thus, the surprising finding, that controlling the color shift of the transmitted light beam and optionally the reflected light beam allows to significantly improve the quality of the image when respective beam splitters are used in reflective augmented waveguides. It has also been found that—in some embodiments—additional controlling the phase of the transmitted light beam allows to significantly improve the quality of the image when respective beam splitters are used in reflective augmented reality waveguides.

The inventors believe that the minor differences in the propagation paths of the plurality of light beams which are emitted by the projector for different colors and/or different pixels of the image to be presented and which light beams are mixed in the user's eye are less critical if the color shift and preferably the phase difference is controlled as stated for the light beams which are transmitted through the beam splitters.

Thus, if for a respective angle of incidence in the range from 15° to 75°, preferably 15° to 45°, preferably from 20 to 42°, particularly with an angle of 32° and for a respective specific wavelength within the range of 400 to 730 nm, preferably 420 nm to 680 nm, more preferably 430 nm to 650 nm and particularly preferably 450 nm and 650 nm of the specific light beam a respective color shift is set up, the beam splitter can be used for providing high quality images to a user.

In addition, preferably the structures of the beam splitter are not substantially affecting the appearance of the user's eye to some third person when used in an AR (augmented reality) device such as AR glasses. Generally, the appearance of the user's eye to a third person might be affected by the antireflective effect of the coating in the direction of the line of sight between the user's eye and the third person. It is therefore preferred if in the angular range, where the AR-picture is guided, the reflection is higher than in the angular range, where the user looks through the beam splitter to the outside world. For example, the main propagation direction of the light, especially the transmitted part of the light, (such as the specific light beam) within the beam splitter may be chosen such that it is different, especially perpendicular to the direction of the line of sight between the user's eyes and the third person.

Preferably, it is clear to the person skilled in the art that the difference between the CIE x coordinates and respectively the y coordinates of the specific light beam and the CIE x coordinates and respectively the y coordinates of the specific light beam after transmitting through the beam splitter is evaluated by measuring (1) the CIE x and y coordinates of the light beam incident on the beam splitter and (2) the CIE x and y coordinates of the transmitted light beam through the beam splitter. It is also clear to the person skilled in the art that the difference between the CIE x coordinates and respectively the y coordinates of the specific light beam and the CIE x coordinates and respectively the y coordinates of the reflected light beam is evaluated by measuring (1) the CIE x and y coordinates of the light beam incident on the beam splitter and (2) the CIE x and y coordinates of the reflected light beam.

For the purpose of the present invention, “color shift” denotes the difference between the CIE x,y coordinates of the specific light beam and the transmitted respectively the reflected (partial) light beam).

For the purpose of the invention the transmitted part of the light beam also is denotes as “transmitted light beam” or the “transmitted partial light beam” and the reflected part of the light beam also is denoted as “reflected light beam” or the “reflected partial light beam”.

The color shift can be obtained by spectral photometric measurements of the specific light beam and the respective reflected and/or transmitted light beam, transferring the obtained measurement data into CIE color coordinates according to the CIE standard observer functions, and calculate the difference between the CIE color coordinated of the specific light beam and the respective reflective and/or transmitted light beam.

Preferably, the specific light beam is incident on the beam splitter at a first surface of the beam splitter, such as a first main surface of the beam splitter. In particular, the first surface of the beam splitter is an outer surface of the coating.

Preferably, for evaluating the color shift, the transmitted portion of the specific light beam at a second surface of the beam splitter, such as a second main surface of the beam splitter is used. In particular, the second surface of the beam splitter is an outer surface of the beam splitter facing in the opposite direction than the outer surface of the coating.

According to the invention the specific light beam after transmitting through the beam splitter has difference between the CIE x coordinates of the specific light beam and the CIE x coordinates of the specific light beam after transmitting through the beam splitter is less than 0.05, preferably less than 0.025, more preferably less than 0.005 and/or the difference between the CIE y coordinates of the specific light beam and the CIE y coordinates of the specific light beam after transmitting through the beam splitter is less than 0.05, preferably 0.025, more preferably less than 0.005.

Preferably, the specific light beam incident on the beam splitter has a chromaticity according to CIE of x in the range from 0.283 to 0.383, preferably in the range from 0.300 and 0.360, more preferably in the range from 0.310 and 0.350 and particularly preferably in the range from 0.320 to 0.340, and/or a chromaticity according to CIE of y in the range from 0.283 to 0.383, preferably in the range from 0.300 and 0.360, more preferably in the range from 0.310 and 0.350 and particularly preferably in the range from 0.320 to 0.340.

Preferably, the transmitted partial light beam has a chromaticity according to CIE of x in the range from 0.283 to 0.383, preferably in the range from 0.300 and 0.360, more preferably in the range from 0.310 and 0.350 and particularly preferably in the range from 0.320 to 0.340, and/or a chromaticity according to CIE of y in the range from 0.283 to 0.383, preferably in the range from 0.300 and 0.360, more preferably in the range from 0.310 and 0.350 and particularly preferably in the range from 0.320 to 0.340.

Preferably the beam splitter is designed so that a light beam according to the specific light beam is partially reflected by and partially transmitted through the beam splitter. The specific light beam incident on the beam splitter is, hence, split up in at least two partial light beams.

The specific light beam incident on the beam splitter, the reflected light beam and the transmitted light beam preferably propagate in a common propagation plane. Especially the angle between the first and second directions is measured within this common propagation plane.

Preferably, the reflected light beam has a difference between the CIE x coordinates of the specific light beam and the CIE x coordinates of the reflected light beam of less than 0.05, preferably less than 0.025, more preferably less than 0.005 and/or a difference between the CIE y coordinates of the specific light beam and the CIE y coordinates of the reflected light beam of less than 0.05, preferably 0.025, more preferably less than 0.005.

Preferably, the reflected light beam has a chromaticity according to CIE of x in the range from 0.283 to 0.383, preferably in the range from 0.300 and 0.360, more preferably in the range from 0.310 and 0.350 and particularly preferably in the range from 0.320 to 0.340, and/or a chromaticity according to CIE of y in the range from 0.283 to 0.383, preferably in the range from 0.300 and 0.360, more preferably in the range from 0.310 and 0.350 and particularly preferably in the range from 0.320 to 0.340.

Optionally, the maximal color shift criterions are fulfilled for the beam splitter having a temperature of between 0° C. and 60° C., such as 20° C. (e.g. the ambient temperature may be within this range). In other words, the color shift for the beam splitter preferably is evaluated while it has a temperature within said temperature range. It is, therefore, possible that for a light beam having a specific angle of incidence of for example 30° or 32° and the specific wavelength the color shift which is evaluated is according to CIE x 0.05 or more and y 0.05 or more, if the beam splitter has a temperature outside of the stated range.

In one embodiment the color shift fulfills the maximum color shift criterion for each specific wavelength in the stated range. In other words, the figure of merit is not only for (at least) one single wavelength chosen as specific wavelength fulfilled but for every wavelength within the stated range.

Preferably, the beam splitter according to the invention has a wavelength dependent transmittance and a wavelength dependent reflectance,
wherein for at least one specific incident angle, preferably for all incident angles in the range from 15° to 60°, preferably in the range from 15° to 45° and/or in the range from 20 to 42°, and/or at an incident angle of 30° and/or of 60°,
the beam splitter has a maximum transmittance T₍₄₂₀₋₆₈₀₎ₘₐₓ and a minimum transmittance T₍₄₂₀₋₆₈₀₎ₘᵢₙ in a wavelength range of from 420 nm to 680 nm, and wherein the difference between T₍₄₂₀₋₆₈₀₎ₘₐₓ and T₍₄₂₀₋₆₈₀₎ₘᵢₙ is less than 10%, preferably less than 7%, more preferably less than 5%, particularly preferably less than 3% and/or
wherein the beam splitter has a maximum reflectance R₍₄₂₀₋₆₈₀₎ₘₐₓ and a minimum reflectance R₍₄₂₀₋₆₈₀₎ₘᵢₙ in a wavelength range of from 420 nm to 680 nm, wherein the difference between R₍₄₂₀₋₆₈₀₎ₘₐₓ and R₍₄₂₀₋₆₈₀₎ₘᵢₙ is less than 10%, preferably less than 7%, more preferably less than 5%, particularly preferably less than 3% and/or
the beam splitter has a maximum transmittance T₍₄₃₀₎ₘₐₓ and a minimum transmittance T₍₄₃₀₎ₘᵢₙ at 430 nm and wherein the difference between T₍₄₃₀₎ₘₐₓ and T₍₄₃₀₎ₘᵢₙ is less than 10%, preferably less than 5%, more preferably less than 3%, particularly preferably less than 2%, and/or
the beam splitter has a maximum reflectance R₍₄₃₀₎ₘₐₓ and a minimum reflectance R₍₄₃₀₎ₘᵢₙ at 430 nm, wherein the difference between R₍₄₃₀₎ₘₐₓ and R₍₄₃₀₎ₘᵢₙ is less than 10%, preferably less than 5%, more preferably less than 3%, particularly preferably less than 2%, and/or
the beam splitter has a maximum transmittance T₍₅₃₅₎ₘₐₓ and a minimum transmittance T₍₅₃₅₎ₘᵢₙ at 535 nm, wherein the difference between T₍₅₃₅₎ₘₐₓ and T₍₅₃₅₎ₘᵢₙ is less than 10%, preferably less than 5%, more preferably less than 3%, particularly preferably less than 2%, and/or
the beam splitter has a maximum reflectance R₍₅₃₅₎ₘₐₓ and a minimum reflectance R₍₅₃₅₎ₘᵢₙ at 535 nm, wherein the difference between R₍₅₃₅₎ₘₐₓ and R₍₅₃₅₎ₘᵢₙ is less than 10%, preferably less than 5%, more preferably less than 3%, particularly preferably less than 2%, and/or
the beam splitter has a maximum transmittance T₍₅₆₅₎ₘₐₓ and a minimum transmittance T₍₅₆₅₎ₘᵢₙ at 565 nm, wherein the difference between T₍₅₆₅₎ₘₐₓ and T₍₅₆₅₎ₘᵢₙ is less than 10%, preferably less than 5%, more preferably less than 3%, particularly preferably less than 2%, and/or
the beam splitter has a maximum reflectance R₍₅₆₅₎ₘₐₓ and a minimum reflectance R₍₅₆₅₎ₘᵢₙ at 565 nm, wherein the difference between R₍₅₆₅₎ₘₐₓ and R₍₅₆₅₎ₘᵢₙ is less than 10%, preferably less than 5%, more preferably less than 3%, particularly preferably less than 2%.

In preferred embodiments the invention relates to a beam splitter according to the invention,
wherein for light having a specific wavelength within the range of 450 nm and 650 nm
which is incident on the beam splitter along a second direction with an incident angle of 30° enclosed between a vector pointing in said first direction and a vector pointing in said second direction, said specific light beam after transmitting through the beam splitter has a phase having a phase difference of an absolute value of less than or equal to 30° compared to the case in which, under otherwise identical conditions, the beam splitter is replaced by a reference substrate made of the substrate material and having a thickness identical to the total thickness of the beam splitter.

In some preferred embodiments of the beam splitter according to the invention, the phase difference has an absolute value which is less than or equal to 20°, less than or equal to 15°, less than or equal to 10°, less than or equal to 7°, less than or equal to 5°, less than or equal to 3°, or less than or equal to 1°, and/or is greater than or equal to 0.5°, greater than or equal to 1°, greater than or equal to 2°, or greater than or equal to 5°.

Preferably it is clear to the person skilled in the art that the phase difference is evaluated between (1.) the specific light beam that has transmitted through the beam splitter and (2.) the specific light beam that has, under otherwise identical conditions, transmitted through the reference substrate which has a thickness corresponding to the total thickness of the beam splitter.

Preferably, the specific light beam is incident on the beam splitter at a first surface of the beam splitter, such as a first main surface of the beam splitter. In particular, the first surface of the beam splitter is an outer surface of the coating. Preferably, for evaluating the phase difference, the transmitted portion of the specific light beam at a second surface of the beam splitter, such as a second main surface of the beam splitter is used. In particular, the second surface of the beam splitter is an outer surface of the beam splitter facing in the opposite direction than the outer surface of the coating.

Likewise, for the reference substrate, the specific light beam is incident on the reference substrate at a first surface of the reference substrate, such as a first main surface of the reference substrate. In particular, the first surface of the reference substrate is an outer surface and/or a main surface of the reference substrate. Preferably, for evaluating the phase difference, the transmitted portion of the specific light beam at a second surface of the reference substrate, such as a second main surface of the reference substrate is used. In particular, the second surface of the reference substrate is an outer surface and/or a main surface of the reference substrate facing in the opposite direction than the other outer surface of the reference substrate.

The term “variable X is between Y and Z” when used in this application preferably means that variable X can take any value which is between Y and Z, inclusive Y and Z. For example, the variable X may take the value Y, the value Z or any value which is in between.

The specific light beam preferably is incident on the beam splitter at a coupling point, which preferably is within the first main surface of the beam splitter and/or leaves the beam splitter at an exit point which preferably is within the second main surface of the beam splitter.

In some preferred embodiments the specific light beam after transmitting through the beam splitter has a phase having a phase difference of an absolute value of less than or equal to 30° compared to the case in which, under otherwise identical conditions, the beam splitter is replaced by a reference substrate made of the substrate material and having a thickness identical to the total thickness of the beam splitter.

The phase difference can be measured using optical analysis. In the optical analysis, an specific angle in the range from 15° to 45°, preferably from 20 to 42°, particularly preferably with an angle of 30° enclosed between said first direction and said second direction (i.e. the angle of incidence) can be measured for the specific light beam propagating within an incident medium (which preferably is provided by means of and/or in form of a coupling element), which is made of the same material as the substrate. Preferably, the incident medium is directly or indirectly (e.g. via an adhesive layer) attached to the beam splitter. The incident medium could be for example in form of a prism. Preferably, the second direction is the direction of the propagation path of the specific light beam within the coupling element.

Preferably the reference wavefront for the phase difference is the wavefront which starts propagating from the coupling element.

It turned out that in principle for higher angles of incident higher phase differences might be accepted while still obtaining a high-quality image. Of course, when the beam splitter is in use, the beam splitter preferably allows to be used over a wide range of angles of incidence. However, if for the stated angle of incidence, the phase difference fulfills the maximum threshold criterion, it turned out that such a beam splitter is highly preferred.

Preferably, the maximum threshold criterion is fulfilled for angles of incidence in the range between 3° and 80°, especially between 10° and 70°, especially between 10° and 50° or between 10° and 40° or between 55° and 75° or between 45° and 75° or between 15° to 45° or between 20° to 40°.

Preferably, the first direction is also parallel to the normal vector of the main surface of the beam splitter. The angle of incidence is then preferably stated with respect to that normal vector.

The relation between the angle of incidence, the specific wavelength of the specific light beam and the maximal phase difference allowed for the phase difference can preferably define a figure of merit. Hence, in an embodiment, the beam splitter fulfills the maximal phase difference criterion for the specific light beam (which is incident under the angle of incidence, and which has a wavelength according to the specific wavelength).

For example, the substrate is made of glass ceramics, glass, optoceramics, optical polymers and/or ceramics. In one embodiment, the substrate is made of a material which is transparent, at least for a wavelength in the range of 400 nm and 730 nm, preferably in the range of 450 nm and 650 nm and/or the specific wavelength.

The beam splitter is designed so that a light beam according to the specific light beam is partially reflected by and partially transmitted through the beam splitter. The specific light beam incident on the beam splitter is, hence, split up in at least two partial light beams, also denoted as “transmitted light beam” and “reflected light beam”.

The specific light beam incident on the beam splitter, the reflected light beam and the transmitted light beam preferably propagate in a common propagation plane. Especially the angle between the first and second directions is measured within this common propagation plane.

In one embodiment the phase difference fulfills the maximum threshold criterion for each specific wavelength in the stated range. In other words, the figure of merit is not only for (at least) one single wavelength chosen as specific wavelength fulfilled but for every wavelength within the stated range.

As an alternative to an optical analysis of the phase difference, the composition of substrate material and any coatings on a given beam splitter can be analyzed using ToF-SIMS and/or FIB-SIMS. The thicknesses of substrates and coating layers can be determined by electron microscopy. Finally, the phase difference can be calculated from the refractive indexes of the coating and substrate materials.

The analysis methods (such as ToF-SIMS and/or FIB-SIMS) allow identification of the materials and the thicknesses of the coating layers. Refractive index information can be obtained experimentally or derived from existing databases. Based on this information the optical properties of the coatings like spectral and angular transmittance, reflectance, phase and retardance may be evaluated for a light beam incidence on the beam splitter.

Preferably, of course, the total thickness of the beam splitter (especially measured along the first direction) is identical to the total thickness of the substrate and all coatings (especially respectively measured along the first direction).

Optionally, the maximal phase difference criterion is fulfilled for the beam splitter having a temperature of between 0° C. and 60° C., such as 20° C. (e.g. the ambient temperature may be within this range). In other words, the phase difference for the beam splitter preferably is evaluated while it has a temperature within said temperature range. It is, therefore, possible that for a light beam having an specific angle of incidence of for example 30° and the specific wavelength the phase difference which is evaluated is greater than 30° if the beam splitter has a temperature outside of the stated range.

It is clear for the person skilled in the art that the beam splitter has optionally a defined reflectivity and/or a defined transmittivity for the specific light beam incident thereon. The coating (in combination with the substrate) has the beneficial effect that a partial reflection of the specific light beam can be achieved while at the same time the phase of the specific light beam after transmission through the beam splitter can be controlled in a precise manner.

Optionally, the term “main surface” (of an element) may be understood as one of the main surfaces with the largest surface. An element may have more than one main surface. For example, a substrate, such as the substrate of the beam splitter, may have two main surfaces (which are parallel to each other). For example, the beam splitter may have two main surfaces, with one main surface of those being an outer surface of the coating.

In one embodiment it might be alternatively or in addition preferred the specific wavelength is between 500 nm and 600 nm, especially is 550 nm, 546 nm or 587 nm. A wavelength selected from this range is beneficial because they are well suited for augmented reality applications. For example, the specific wavelength might be between 500 nm and 550 nm or between 550 nm and 600 nm.

In one embodiment it might be alternatively or in addition preferred that the phase difference has an absolute value which is less than or equal to 20°, less than or equal to 15°, less than or equal to 10°, less than or equal to 7°, less than or equal to 5°, less than or equal to 3°, or less than or equal to 1°.

In one embodiment it might be alternatively or in addition preferred that the phase difference has an absolute value which is greater than or equal to 0.5°, greater than or equal to 1°, greater than or equal to 2°, or greater than or equal to 5°.

Preferably the absolute value of the phase difference is greater than or equal to 10° and less than or equal to 30°. This is a trade-off between higher manufacturing costs and improvements in the image quality.

Preferably, the coating has a refractive index n_{c} corresponding to the refractive index of the substrate nₛ, or the ratio of the refractive index of the coating (n_{c}) and the refractive index at a of the substrate (nₛ) at a specific wavelength is between 0.95 and 1.05, preferably between 0.99 and 1.01, and more preferably between than 0.995 and 1.005 and/or wherein an absolute value of the difference of the refractive index of the substrate (nₛ) and the refractive index of the coating (n_{c}) is 1.00 or less, 0.50 or less, 0.10 or less, 0.07 or less, 0.05 or less, 0.03 or less, 0.02 or less, 0.01 or less, 0.005 or less, 0.001 or less, or 0.0005 or less; and/or is 0.0001 or greater, 0.0002 or greater, 0.0003 or greater, or 0.0004 or greater.

Preferably, the specific wavelength is between 450 to 650 nm, preferably between 500 nm and 600 nm, especially is 525 nm, 546 nm, 550 nm or 587 nm.

This allows to provide a soft transition for the specific light beam between the coating and the substrate which turned out to be particularly beneficial for improving the image quality.

Preferably the refractive index of the coating is an average refractive index of the coating.

In one embodiment it might be alternatively or in addition preferred that the coating has at least two layers and/or between 1 and 5000 layers, between 2 and 50 layers, between 5 and 40 layers, or between 7 and 35 layers.

If the coating is a multi-layer coating, it is possible to selectively improve the image quality for a particular wavelength or a particular range of wavelengths.

According to the invention, the refractive index of the coating is adjusted in a precise manner by combining-if there is not a coating with suitable index-one or more layers with low and one or more layers with high refractive index to achieve the target refractive index of the coating.

For the purpose of the invention, a layer with low refractive index means a layer with a refractive index lower than the refractive index of the substrate a layer with high refractive index means a layer with a refractive index higher than the refractive index of the substrate, especially for a wavelength of 550 nm and/or for the specific wavelength.

Preferably, the main surfaces of all layers of the coating are parallel to each other and/or to the man surface of the substrate.

Preferably, the absolute value of the difference between the minimum refractive index of one of the layers and the maximum refractive index of one of the layers is 1.5 or less, preferably 1.3 or less, preferably 1.0 or less, preferably 0.70 or less, preferably 0.50 or less, preferably 0.30 or less, preferably 0.10 or less, preferably 0.05 or less, preferably 0.01 or less, especially for a wavelength of 550 nm and/or for the specific wavelength.

Preferably the refractive index of each layer is between 1.1 and 2.5, especially for a wavelength of 550 nm and/or for the specific wavelength.

In one embodiment it might be alternatively or in addition preferred that a thickness of each layer of the coating along the first direction
is greater than or equal to 1 nm, greater than or equal to 4 nm, greater than or equal to 8 nm, greater than or equal to 10 nm, or greater than or equal to 15 nm; and/or
is less than or equal to 5000 nm, less than or equal to 3000 nm, less than or equal to 2000 nm, less than or equal to 1000 nm, or less than or equal to 500 nm; and/or
is between 1 nm and 5000 nm, between 4 nm and 3000 nm, between 8 nm and 2000 nm, between 10 nm and 1000 nm, or between 15 nm and 500 nm.

Respective thicknesses can be produced with well-known techniques which might keep the manufacturing costs low.

Preferably, the thickness of each layer whose refractive index is close to the refractive index of the substrate (e.g. the refractive index of the layer is from 90% to 110% of the refractive index of the substrate) is from 10 nm to 750 nm, the thickness of each layer whose refractive index is high (e.g. higher than 110% of the refractive index of the substrate) is from 4 nm to 50 nm and/or the thickness of each layer whose refractive index is low (e.g. less than 90% of the refractive index of the substrate) is from 50 nm to 200 nm.

In one embodiment, at least one layer of the coating is a dielectric layer, especially all layers of the coating are dielectric layers, and/or at least one layer of the coating, especially the at least one layer having a thickness along the first direction of 10 nm or less, consists of and/or comprises metal, such as Ag, and/or the coating has no layers made of and/or comprising metal.

For a dielectric layer the optical properties of the respective layer can be advantageously controlled. This in turn allows to produce well-defined coatings with respect to specific demands for optical properties such as reflectivity and transmittivity.

A metal-free coating is particularly beneficial for the use as beam splitter.

In one embodiment it might be alternatively or in addition preferred that the coating has at least one spatially variable index layer or is made of one single spatially variable index layer.

A spatially variable index layer is easy to produce with convenient techniques but turned out to provide beneficial results with respect to controlling the color shift and optionally the phase of the specific light beam. A spatially variable index layer may be realized in form of a rugate design.

A spatially variable index layer in the sense of the present application may be a layer which has a refractive index which changes, especially increases and/or decreases, along the first direction, especially in sections.

Alternatively, or in addition to a spatially variable index layer also a gradient filter might be used.

In one embodiment it might be alternatively or in addition preferred that the coating is at least partially applied to the substrate by physical vapor deposition (PVD), preferably sputtering.

The process of sputtering can be controlled in a precise manner so that it is beneficial used for applying the coating (or at least one or more of the multiple layers of the coating) to the substrate.

Alternatively, CVD (chemical vapor deposition), PICVD (plasma-impulse CVD) or ALD (atomic layer deposition) might be used for applying the coating on the substrate.

In one embodiment it might be alternatively or in addition preferred that at least one layer of the coating constitutes a matching layer, and wherein optionally
(i) the matching layer has a refractive index and/or an optical dispersion essentially corresponding to the refractive index and/or the dispersion pattern, respectively, of the substrate,
(ii) the ratio of the refractive index of the matching layer and the refractive index of the substrate is between 0.9 and 1.1,
(iii) the matching layer has a thickness of between 200 nm and 400 nm,
(iv) the matching layer is arranged directly on the substrate, in particular by deposition and/or as an adhesive layer,
(v) two or more layers of the coating each constitute a matching layer, and/or
(vi) the total thickness of all matching layers of the coating is greater than the thickness of each of the other layers of the coating.

In another embodiment it might be alternatively or in addition preferred that at least one layer of the coating constitutes a matching layer, and wherein optionally
(i) the matching layer has a refractive index and/or an optical dispersion essentially corresponding to the refractive index and/or the dispersion pattern, respectively, of the substrate,
(ii) the ratio of the refractive index of the matching layer and the refractive index of the substrate is between 0.95 and 1.05,
(iii) the matching layer has a thickness of between 15 nm and 750 nm, preferably between 20 nm to 600 nm,
(iv) the matching layer is arranged directly on the substrate, in particular by deposition and/or as an adhesive layer,
(v) two or more layers of the coating each constitute a matching layer, and/or
(vi) the total thickness of all matching layers of the coating is greater than the thickness of each of the other layers of the coating
(vii) the total thickness of all matching layers of the coating is in the range from 250 nm to 1750 nm, preferably from 500 nm to 1500 nm.

The matching layer allows matching the phase properties of the coating to those of the substrate. The position in the coating stack may be variable, as well as the thickness and the refractive index of the matching layer may be subject to design options.

The matching layer does not have to be arranged directly on the substrate. Its position in the coating (e.g. along the first direction) may be determined by reflectance and chromaticity conditions.

It is particularly preferred that the matching layer has an identical or similar refractive index than the substrate material. It turned out that in this way it is possible to obtain a beam splitter while at the same time controlling the phase is possible.

Especially, the matching layer may be used to control the phase of the specific light beam while the other layers of the coating may be used for controlling the reflectivity and/or transmittivity of the beam splitter and/or of the coating.

The total thickness of all matching layers may be measured along the first direction. Likewise, also the thickness of each of the other layers of the coating may be measured along the first direction.

In one preferred embodiment, the coating has at least two layers and one of those layers is the matching layer. In another preferred embodiment, the coating has at least three layers and two layers are matching layers.

The matching layer might be realized in form of a spatially variable index layer.

In one embodiment the coating is identical to one single matching layer.

The values of the refractive indexes of the matching layer and the substrate preferably are identical if the ratio of the refractive index of the matching layer and the refractive index of the substrate is between 0.95 and 1.05.

Preferably, the absolute value of the difference between the refractive index of the matching layer and the refractive index of the substrate is 0.1 or less, preferably 0.05 or less, preferably 0.02 or less, preferably 0.01 or less.

For example, the thickness of the matching layer, in one embodiment, is from 50 nm to 200 nm, such as from 50 nm to 100 nm or from 100 nm to 200 nm.

Preferably the two refractive indexes (of the substrate material and the matching layer) as indicated in this disclosure relate to a wavelength of 550 nm (i.e. refractive index n_{d}) and/or the specific wavelength.

In one embodiment, the matching layer
(i) comprises SiO₂ and/or Al₂O₃, in particular in combination with an alkaline earth oxide containing flint glass as a substrate material, and/or
(ii) is made of SiO₂, in particular in combination with a boron containing crown glass as a substrate material.

In embodiments, the material of the matching layer may be mixed materials of highly refractive materials (e.g. Ta₂O₅) and low refractive materials (e.g. SiO₂), such as a mixture of Al₂O₃ and SiO₂.

In one embodiment, it is preferred that the coating comprises
(i) at least one matching layer, wherein preferably the ratio of the refractive index of the matching layer and the refractive index of the substrate is between 0.95 and 1.05,
(ii) at least one layer having a high refractive index, wherein preferably the ratio of the refractive index of the high refractive index layer and the refractive index of the substrate is more than 1.05,
(iii) at least one further layer having a further refractive index, wherein preferably the ratio of the further refractive index of the further layer and the refractive index of the substrate is less than 0.95 and/or more than 1.05, wherein the at least one further layer preferably is different from the at least one layer having a high refractive index.

In one embodiment, it is preferred that the coating comprises
(i) at least one matching layer, wherein preferably the ratio of the refractive index of the matching layer and the refractive index of the substrate is between 0.95 and 1.05, preferably Al₂O₃;
(ii) at least one layer having a high refractive index, wherein preferably the ratio of the refractive index of the high refractive index layer and the refractive index of the substrate is more than 1.05, preferably Ta₂O₅,
(iii) at least one layer having a low refractive index, wherein preferably the ratio of the refractive index of the low refractive index layer and the refractive index of the substrate is less than 0.95, preferably SiO₂.

In one embodiment it is preferred, that the coating comprises
(i) at least one matching layer, wherein preferably the ratio of the refractive index of the matching layer and the refractive index of the substrate is between 0.95 and 1.05, preferably SiO₂
(ii) at least a first layer having a high refractive index, wherein preferably the ratio of the refractive index of the first high refractive index layer and the refractive index of the substrate is more than 1.05,
(iii) at least a second layer having a high refractive index, wherein preferably the ratio of the refractive index of the second high refractive index layer and the refractive index of the substrate is more than 1.05;
wherein the first layer and the second layer may comprise or consist of the same material or comprise or consist of different materials, preferably comprise or consist of different materials, preferably Al₂O₃ and Ta₂O₅.

In embodiments, the substrate material is or comprises a glass, such as a silicate glass, e.g. a barium containing silicate glass. For example, the substrate material may comprise or consist of a flint glass or a crown glass. Optionally, the glass is selected from an alkaline earth oxide containing flint glass, a barium flint glass, a barium crown glass, a boron containing crown glass, a lanthanum flint glass, a lanthanum crown glass, a dense crown glass and combinations thereof. It turned out that respective materials, especially combination of materials, allow to produce a particular well-suited transition between the coating and the substrate for the specific light beam.

Optionally, the coating may comprise or consist of one or more components selected from one or more oxides, one or more fluorides, one or more nitrides, one or more sulfides, one or more selenides, one or more metals, and combinations of two or more thereof. For example, the coating may comprise or consist of one or more components selected from one or more metal oxides, one or more metal fluorides, one or more metal nitrides, one or more metal sulfides, one or more metal selenides and combinations of two or more thereof. The oxide may be selected from silicon oxide, aluminum oxide, hafnium oxide, tantalum oxide, niobium oxide, titanium oxide, zirconium oxide, yttrium oxide, praseodymium oxide, scandium oxide, tin oxide, chromium oxide, indium oxide and combinations of two or more thereof. Optionally, the combination of two or more oxides is a mixed oxide. The fluorides may be selected from aluminum fluoride, magnesium fluoride, neodymium fluoride, lanthanum fluoride, yttrium fluoride, gadolinium fluoride, ytterbium fluoride and combinations of two or more thereof. The nitrides may be selected from aluminum nitride, silicon nitrides and combinations thereof. The sulfides may include zinc sulfide. The selenides may include zinc selenide. The metals may be selected from aluminum, silver, gold, chromium, nickel and combinations thereof. Optionally, the combination of two or more metals is an alloy. Preferably, any metal layer should have a thickness along the first direction of 10 nm or lower to provide for sufficient transparency. Optional mixed oxides are selected from oxides of aluminum and praseodymium, aluminum and lanthanum, aluminum and tantalum, praseodymium and titanium, zirconium and titanium, lanthanum and titanium as well as niobium and titanium.

Optionally, the coating may comprise at least one layer comprising or consisting of one or more components selected from one or more oxides, one or more fluorides, one or more nitrides, one or more sulfides, one or more selenides, one or more metals, and combinations of two or more thereof. For example, the layer may comprise or consist of one or more components selected from one or more metal oxides, one or more metal fluorides, one or more metal nitrides, one or more metal sulfides, one or more metal selenides and combinations of two or more thereof. The oxide may be selected from silicon oxide, aluminum oxide, hafnium oxide, tantalum oxide, niobium oxide, titanium oxide, zirconium oxide, yttrium oxide, praseodymium oxide, scandium oxide, tin oxide, chromium oxide, indium oxide and combinations of two or more thereof. Optionally, the combination of two or more oxides is a mixed oxide. The fluorides may be selected from aluminum fluoride, magnesium fluoride, neodymium fluoride, lanthanum fluoride, yttrium fluoride, gadolinium fluoride, ytterbium fluoride and combinations of two or more thereof. The nitrides may be selected from aluminum nitride, silicon nitrides and combinations thereof. The sulfides may include zinc sulfide. The selenides may include zinc selenide. The metals may be selected from aluminum, silver, gold, chromium, nickel and combinations thereof. Optionally, the combination of two or more metals is an alloy. Preferably, any metal layer should have a thickness along the first direction of 10 nm or lower to provide for sufficient transparency. Optional mixed oxides are selected from oxides of aluminum and praseodymium, aluminum and lanthanum, aluminum and tantalum, praseodymium and titanium, zirconium and titanium, lanthanum and titanium as well as niobium and titanium.

Optionally, one or more matching layers may comprise or consist of one or more components selected from one or more oxides, one or more fluorides, one or more nitrides, one or more sulfides, one or more selenides, one or more metals, and combinations of two or more thereof. For example, the layer may comprise or consist of one or more components selected from one or more metal oxides, one or more metal fluorides, one or more metal nitrides, one or more metal sulfides, one or more metal selenides and combinations of two or more thereof. The oxide may be selected from silicon oxide, aluminum oxide, hafnium oxide, tantalum oxide, niobium oxide, titanium oxide, zirconium oxide, yttrium oxide, praseodymium oxide, scandium oxide, tin oxide, chromium oxide, indium oxide and combinations of two or more thereof. Optionally, the combination of two or more oxides is a mixed oxide. The fluorides may be selected from aluminum fluoride, magnesium fluoride, neodymium fluoride, lanthanum fluoride, yttrium fluoride, gadolinium fluoride, ytterbium fluoride and combinations of two or more thereof. The nitrides may be selected from aluminum nitride, silicon nitrides and combinations thereof. The sulfides may include zinc sulfide. The selenides may include zinc selenide. The metals may be selected from aluminum, silver, gold, chromium, nickel and combinations thereof. Optionally, the combination of two or more metals is an alloy. Preferably, any metal layer should have a thickness along the first direction of 10 nm or lower to provide for sufficient transparency. Optional mixed oxides are selected from oxides of aluminum and praseodymium, aluminum and lanthanum, aluminum and tantalum, praseodymium and titanium, zirconium and titanium, lanthanum and titanium as well as niobium and titanium.

Optionally, the coating may comprise a layer having a first oxide and a further layer having a second oxide, the first and second oxides being the same or different. In certain embodiments, the coating has at least 3 layers, at least 4 layers, at least 6 layers or at least 8 layers. By choosing the appropriate material for the various layers, optical properties can be matched as desired. For example, the coating may comprise Ta₂O₅ and/or SiO₂ (especially in combination with a boron containing crown glass as a substrate material). Also, optionally the coating may comprise layers of respectively Ta₂O₅, SiO₂ and/or Al₂O₃ and/or a matching layer which comprises SiO₂ and Al₂O₃ (especially in combination with an alkaline earth oxide containing flint glass as a substrate material). Also optionally, the coating may comprise layers of hafnium oxide (HfO₂) and SiO₂, wherein, in one embodiment, the thickness of the hafnium oxide (HfO₂) layer is less than the thickness of the SiO₂ layer. Also optionally, the coating may comprise layers of Ta₂O₅ und SiO₂, wherein, in one embodiment, the thickness of the Ta₂O₅ layer is less than the thickness of the SiO₂ layer (which may be from 78 nm to 230 nm). The material of the coating can be selected based on the desired refractive index or dispersion properties.

In one embodiment it might be alternatively or in addition preferred that a thickness of the coating along the first direction
is greater than or equal to 500 nm, greater than or equal to 800 nm, greater than or equal to 1000 nm, greater than or equal to 1500 nm, or greater than or equal to 2000 nm; and/or
is less than or equal to 3000 nm, less than or equal to 2000 nm, less than or equal to 1500 nm, less than or equal to 1000 nm, or less than or equal to 700 nm; and/or
is between 500 nm and 3000 nm, between 500 nm and 2000 nm, between 700 nm and 1500 nm, between 1000 nm and 1400 nm, or between 1100 nm and 1300 nm, especially about 1200 nm.

Respective thicknesses can be produced with well-known techniques which might keep the manufacturing costs low.

In one embodiment it might be alternatively or in addition preferred that a refractive index of the coating
is 1.45 or greater, 1.47 or greater, 1.50 or greater, 1.51 or greater, or 1.60 or greater; and/or
is 3.00 or less, 2.50 or less, 2.00 or less, or 1.80 or less.

Choosing a respective refractive index of the coating turned out to be particularly beneficial for improving the image quality. Especially it turned out that adapting the refractive index of the coating as whole, rather than for each and every layer of the coating individually, is sufficient to obtain high quality images.

Preferably the refractive index of the coating is an average refractive index of the coating. For example, the values of the refractive index stated above for the coating might correspond to the value which can be obtained by determining the integral of the refractive index along the thickness of the coating. In case of a discrete-layered coating with a uniform refractive index across each single layer, the integral might become a sum.

For example, the following equation may be used to determine the average refractive index of the coating n̅ for a total thickness of the coating (especially measured along the first direction) being d and the local refractive index of the coating/its layers n(x):

$$\overline{n} = {\int }_{0}^{d} n ( x ) dx / {\int }_{0}^{d} dx .$$

For example, the refractive index of the coating may be regarded as matched to that of the substrate, if for the refractive index of the substrate nₛ the condition n̅=nₛ is satisfied.

The refractive index of the coating preferably is a weighted average of the local refractive index over the coating thickness.

In one embodiment, a thickness of the substrate along the first direction
is greater than or equal to 0.1 mm, greater than or equal to 0.5 mm, greater than or equal to 0.7 mm, greater than or equal to 1.0 mm, or greater than or equal to 5.0 mm; and/or
is less than or equal to 20.0 mm, less than or equal to 15.0 mm, less than or equal to 10.0 mm, less than or equal to 7.0 mm, or less than or equal to 5.0 mm; and/or
is between 0.1 mm and 20.0 mm, between 0.5 mm and 10.0 mm, between 1.0 mm and 5.0 mm, between 2.0 mm and 4.0 mm, or between 2.0 mm and 3.0 mm.

Respective thicknesses can be produced with well-known techniques which might keep the manufacturing costs low.

In one embodiment, a refractive index of the substrate
is 1.45 or greater, 1.47 or greater, 1.50 or greater, 1.51 or greater, or 1.60 or greater; and/or
is 3.00 or less, 2.50 or less, 2.00 or less, or 1.80 or less.

Choosing a respective refractive index of the substrate turned out to be particularly beneficial for improving the image quality.

The term “refractive index” (of the substrate) as used herein may be defined as the indication of the light bending ability of the substrate.

For example, the values of the refractive index stated above for the substrate might correspond to the value which can be obtained by determining the integral of the refractive index along the thickness of the substrate material. In case of a discrete-layered substrate with a uniform refractive index across each single layer, the integral might become a sum.

For example, the following equation may be used to determine the average refractive index of the substrate n̅ for a total thickness of the substrate (especially measured along the first direction) being d and the local refractive index of the substrate n(x):

$$\overline{n} = {\int }_{0}^{d} n ( x ) dx / {\int }_{0}^{d} dx .$$

The refractive index of the substrate preferably is a weighted average of the local refractive index over the substrate thickness.

Preferably the refractive index is specified for a wavelength of 550 nm and/or for the specific wavelength.

Preferably the refractive index of the substrate is an average refractive index of the substrate.

In one embodiment it might be alternatively or in addition preferred that an Abbe number vd of the substrate
is 15 or greater, 30 or greater, 40 or greater, 50 or greater, 70 or greater or 80 or greater; and/or
is 95 or less, 80 or less, 70 or less, 50 or less, 40 or less, 30 or less or 20 or less; and/or
is between 15 and 95, between 35 and 80 or between 40 and 70, such as 44 or 64.

Choosing a respective Abbe number of the substrate turned out to be particularly beneficial for improving the image quality.

Preferably the Abbe number v_{d} of the substrate is an average Abbe number of the substrate.

In one embodiment it might be alternatively or in addition preferred that an absorption coefficient of the substrate is less than 0.4, less than 0.3, less than 0.2, less than 0.1, less than 0.05, less than 0.01, less than 0.005, or less than 0.001.

With a respective absorption coefficient also a plurality of beam splitters might be used in series without significant loss of intensity and, hence, keeping image quality high also under such conditions.

The term “absorption coefficient” as used herein may be defined as a measure for the exponential decay of intensity of a light beam, that is, the value of downward e-folding distance of the original intensity as the energy of the intensity passes through a unit (e.g. one meter) thickness of the substrate material, so that an attenuation coefficient of 1 m⁻¹ means that after passing through 1 meter, the radiation will be reduced by a factor of e to 1/e, and for material with a coefficient of 2 m⁻¹, it will be reduced by e squared, or to 1/e².

Preferably the absorption coefficient of the substrate is specified for a wavelength of 550 nm and/or for the specific wavelength.

In one embodiment it might be alternatively or in addition preferred that the substrate is essentially cuboidal, in particular essentially plate-shaped.

A respective shaped substrate can be easily manufactured. For example, a wafer can be used which is coated with the coating and subsequently a plurality of beam splitter might be cut out from the coated wafer, wherein a portion of the wafer then represents the substrate.

In one embodiment it might be alternatively or in addition preferred that the substrate comprises glass, such as acid resistant and/or alkali resistant glass, especially glass of group 1 and 2 (according to ISO 719:1985), and/or untempered glass.

Glass is particularly preferred because optical properties can precisely be controlled.

Using glass which has not been tempered (i.e. which has not been hardened) might be beneficial because otherwise the interfaces of the substrate might be polarizing.

In one embodiment it might be alternatively or in addition preferred that an absolute value of the difference of the refractive index of the substrate and the refractive index of the coating
is 1.00 or less, 0.50 or less, 0.10 or less, 0.07 or less, 0.05 or less, 0.03 or less, 0.02 or less, 0.01 or less, 0.005 or less, 0.001 or less, or 0.0005 or less; and/or
is 0.0001 or greater, 0.0002 or greater, 0.0003 or greater, or 0.0004 or greater.

A respective tuning of the values of the refractive index of the substrate and the coating is advantageous to provide a beam splitter for high quality images.

Preferably the refractive index of the substrate and/or the coating is an average refractive index of the substrate and/or coating.

Preferably the two refractive indexes are specified for a wavelength of 550 nm and/or for the specific wavelength.

In one embodiment it might be alternatively or in addition preferred that a coating is arranged on each of the two main surfaces of the substrate, wherein optionally the two coatings are identical, in particular identically structured, especially starting from the substrate in each case.

A second coating may act as a stress compensating layer, compensating for the stress caused by the first coating.

If the two main surfaces of the substrate are coated, the phase difference is observed after the specific light beam has been transmitted through the first coating, the substrate and the second coating. Also, the value of the total thickness of the beam splitter accounts for the thicknesses of both coatings along with the thickness of the substrate.

Preferably the two coatings are different.

It surprisingly turned out that even two reflective beams can be created with a beam splitter if both sides of the substrate are coated in the proposed manner, especially if the two coatings are identical in their structure, while at the same time the phase can still be controlled in a precise manner. By coating both main surfaces of the substrate, the beam splitter preferably basically becomes a dual beam splitter in one piece.

The person skilled in the art understands that the two coatings are identically structured starting from the substrate in each case, especially if, when starting from the substrate in the first direction and in the opposite direction, the two coatings have the same structure, in particular the same layer sequence (especially with respect to material and/or thickness).

In one embodiment it might be alternatively or in addition preferred that the beam splitter is partially reflective and/or partially transmissive for the specific light beam incident thereon.

Preferably, the reflectance and transmittance of the beam splitter is controlled by the optical properties of the coating, the optical properties of the substrate and/or the combination between the two.

In one embodiment it might be alternatively or in addition preferred that the coating has
a reflectance of at least 0.03 and/or at most 0.35,
a transmittance of at least 0.65 and/or at most 0.97, and/or
an absorbance of at least 0.001 and/or at most 0.01,
in particular for light of the specific wavelength incident on the beam splitter,
especially at an angle of 30° to the optical axis of the beam splitter, and/or for a value for the refractive index of nₑ.

The respective values for the reflectance, transmittance and/or absorbance of the coating of the beam splitter turned out to be particularly preferred for providing a high-quality image.

Preferably the reflectance, transmittance and/or absorbance, respectively, of the coating is specified for a wavelength of 550 nm and/or for the specific wavelength.

In one embodiment the reflectance of the coating is between 0.03 and 0.09 or between 0.05 and 0.15 or between 0.1 and 0.25 or between 0.2 and 0.29. For example, the reflectance is between 0.03 and 0.29 or between 0.03 and 0.24.

In one embodiment for the reflectance R, the absorbance A and the transmittance T, respectively of the coating, the equation R+T+A=1 holds, wherein optionally the absorbance A is between 0.001 and 0.01, the reflectance R is between 0.03 and 0.35 and the transmittance T is between 0.65 and 0.97.

The absorbance may be obtained by measuring the reflectance R and the transmittance T and considering energy conservation, so that the relation A=1−R−T holds.

It is preferably possible to use the complex refractive index, n=nr+i*k (wavelength dependent). The values of the extinction coefficient k, like the values of n, are for example available in the databases of optical constants for the coating materials. The relation to the absorption coefficient α [1/m] is given by the following expression (at the vacuum wavelength λ₀):

$$α = \frac{4 π k}{{λ}_{0}}$$

It is preferably possible to determine A, R and T by means of programs for designing coating layers.

The problem is solved by the invention according to a second aspect in that a stack comprising two or more beam splitters according to the first aspect of the invention, wherein optionally the beam splitters are arranged one above the other along a stacking direction, in particular with the stacking direction being parallel to the first direction and/or parallel to the optical axis of the beam splitters, is proposed.

Such a stack is particularly preferred for waveguides for applications in the field of augmented reality.

All the advantages and options that have been described with respect to the beam splitter according to the first aspect of the invention likewise apply to the stack according to the second aspect of the invention. Therefore, reference may be made herein to the previous explanations.

Preferably the substrates of the beam splitters are arranged relative to one another in such a way that the main surfaces of adjacent substrates face one another and/or are parallel to each another.

In one embodiment it might be alternatively or in addition preferred that the beam splitters following one another along the stacking direction or along a direction antiparallel to the stacking direction have a different, in particular increasing or decreasing, reflectivity and/or a different, in particular decreasing or increasing, transmittivity for the portion of the specific light beam incident on them respectively.

Surprisingly, it has been found that a corresponding configuration makes it possible to produce an image with uniform intensity over all parts of the image, even if the light beams contributing to the image pass through a different number of beam splitters.

In one embodiment it might be alternatively or in addition preferred that the specific light beam is guided and/or can be guided along the beam splitters within the stack.

For the person skilled in the art it is clear that along the propagation path of the specific light beam through the stack, the specific light beam is incident on the first beam splitter of the at least two beam splitters. Then, on each subsequent beam splitter of the at least two beam splitters the portion of the specific light beam transmitted at the respective previous beam splitter is incident.

For example, considering a stack with three beam splitters A, B and C (with beam splitter A on top, beam splitter C at the bottom and beam splitter B in between beam splitters A and B) and a specific light beam which is incident on the beam splitter A. Then the transmitted portion of the specific light beam is incident on beam splitter B. And the transmitted portion of the light beam which is incident on beam splitter B is incident on beam splitter C.

In one embodiment it might be alternatively or in addition preferred that at least two, or all, beam splitters are joined together by means of an adhesive, optical contacting and/or low temperature bonding (LTB).

The problem is solved by the invention according to a third aspect in that a method of manufacturing a beam splitter, the method comprises providing a substrate and arranging at least one coating on at least one main surface of the substrate so as to obtain a beam splitter according to the first aspect of the invention, is proposed.

It surprisingly turned out that manufacturing the beam splitter can easily be carried out in the described manner.

In one embodiment also the second main surface of the substrate is coated, especially with an identical coating as applied to the first main surface of the substrate. This second coating is preferably used for stress compensation.

### Examples

The color shift and the phase shift has been evaluated for several beam splitters according to the invention Example 1 to 5. The beam splitters used for the evaluation consists of a substrate made of a glass, e.g. a boron-containing crown glass (e.g. N-BK7) or dense crown glass (e.g. N-SK2), having a thickness of 1 mm, and a multi-layer coating coated onto one main surface of the substrate. The used materials and their refractive index at 550 nm are summarized in Table 1.

TABLE 1
Exemplary used substrates and coating materials

| Material | n @ 550 nm | Description |
|---|---|---|
| N-BK7 | 1,519 | substrate |
| N-SK2 | 1,610 | substrate |
| Ta₂O₅ | 2,186 | layer material H |
| Al₂O₃ | 1,670 | layer material M |
| SiO₂ | 1,479 | layer material L |

Details in regard of the specific substrate and coating materials and thicknesses of the are summarized in Table 2 below. Moreover, the refractive indices of the substrate and the coating are indicated, as well as the phase shift for one specific angle.

TABLE 2
Properties of Examples 1 to 5

| | Ex- | Ex- | Ex- | Ex- | Ex- |
|---|---|---|---|---|---|
| | ample 1 | ample 2 | ample 3 | ample 4 | ample 5 |
| Substrate | N-BK7 | N-BK7 | N-BK7 | N-SK2 | N-SK2 |
| Number of | 13 | 18 | 12 | 19 | 24 |
| Layers | | | | | |
| Total Thickness | 869 | 1476 | 1408 | 1237 | 1455 |
| Coating [nm] | | | | | |
| Total Thickness | 721 | 1344 | 1269 | 481 | 627 |
| of layers L | | | | | |
| [nm] | | | | | |
| Total Thickness | 136 | 70 | 68 | 694 | 808 |
| of layers M | | | | | |
| [nm] | | | | | |
| Total Thickness | 12 | 63 | 71 | 61 | 20 |
| of layers H | | | | | |
| [nm] | | | | | |
| Ratio Total | 83:16:1 | 91:5:4 | 90:5:5 | 39:56:5 | 43:56:1 |
| Thickness L/ | | | | | |
| Total Thickness | | | | | |
| M/Total | | | | | |
| Thickness H | | | | | |
| Refractive | 1.519 | 1.518 | 1.524 | 1.621 | 1.600 |
| Index | | | | | |
| Coating @ | | | | | |
| 550 nm [n_{c}] | | | | | |
| Refractive | 1.519 | 1.519 | 1.519 | 1.610 | 1.610 |
| Index | | | | | |
| Substrate @ | | | | | |
| 550 nm [ns] | | | | | |
| n_{c}/nₛ | 1.000 | 0.999 | 1.003 | 1.007 | 0.994 |
| Phase Shift | −2.76° | −13.13° | −1.61° | −17.08° | 9.19° |
| (550 nm) | (30°) | (65°) | (60°) | (60°) | (30°) |
| at a specific | | | | | |
| incident angle | | | | | |

The color shift properties of Examples 1 to 5 for several incident angles are summarized in Tables 1 to 7. The color shift has been calculated by (1) using an incident light beam (also referred as “specific light beam”) having the color coordinates x_{inc}=0.333, y_{inc}=0.333, (2) evaluating the CIE x, y coordinates for the transmitted light beam (also referred as “transmitted (partial) light beam”) xₜ and yₜ and the CIE x, y coordinates for the reflected light beam (also referred as “reflected (partial) light beam”) xᵣ and yᵣ, (3) calculate the following color shifts for the transmitted light beam and the reflected light beam:
Color shift of transmitted light beam Δxₜ=|x_{inc}−xₜ| and Δyₜ=|y_{inc}−yₜ|
Color shift of reflected light beam Δxᵣ=|x_{inc}−xᵣ| and Δyᵣ=|y_{inc}−yᵣ|

TABLE 3
CIE x, y color coordinates and color shifts - Example 1

| Incident | | | | | | | | |
|---|---|---|---|---|---|---|---|---|
| Angle | xᵣ | yᵣ | Δxᵣ | Δyᵣ | xₜ | yₜ | Δxₜ | Δyₜ |
| 15° | 0.327 | 0.316 | 0.006 | 0.017 | 0.333 | 0.334 | 0.000 | 0.001 |
| 23° | 0.332 | 0.337 | 0.001 | 0.004 | 0.333 | 0.334 | 0.000 | 0.001 |
| 30° | 0.325 | 0.331 | 0.008 | 0.002 | 0.334 | 0.334 | 0.001 | 0.001 |
| 38° | 0.335 | 0.331 | 0.002 | 0.002 | 0.333 | 0.334 | 0.001 | 0.001 |
| 45° | 0.320 | 0.338 | 0.013 | 0.005 | 0.334 | 0.334 | 0.001 | 0.001 |

TABLE 4
CIE x, y color coordinates and color shifts - Example 2

| Incident | | | | | | | | |
|---|---|---|---|---|---|---|---|---|
| Angle | xᵣ | yᵣ | Δxᵣ | Δyᵣ | xₜ | yₜ | Δxₜ | Δyₜ |
| 55° | 0.340 | 0.329 | 0.011 | 0.004 | 0.333 | 0.334 | 0.000 | 0.001 |
| 60° | 0.332 | 0.323 | 0.001 | 0.010 | 0.333 | 0.335 | 0.000 | 0.002 |
| 65° | 0.330 | 0.332 | 0.003 | 0.001 | 0.334 | 0.334 | 0.001 | 0.001 |
| 70° | 0.322 | 0.342 | 0.011 | 0.009 | 0.335 | 0.333 | 0.002 | 0.000 |
| 75° | 0.331 | 0.332 | 0.002 | 0.001 | 0.334 | 0.334 | 0.001 | 0.001 |

TABLE 5
CIE x, y color coordinates and color shifts - Example 3

| Incident | | | | | | | | |
|---|---|---|---|---|---|---|---|---|
| Angle | xᵣ | yᵣ | Δxᵣ | Δyᵣ | xₜ | yₜ | Δxₜ | Δyₜ |
| 55° | 0.326 | 0.343 | 0.007 | 0.010 | 0.336 | 0.331 | 0.003 | 0.002 |
| 58° | 0.326 | 0.330 | 0.007 | 0.003 | 0.336 | 0.336 | 0.003 | 0.003 |
| 60° | 0.329 | 0.339 | 0.004 | 0.006 | 0.335 | 0.332 | 0.002 | 0.001 |
| 63° | 0.329 | 0.346 | 0.004 | 0.013 | 0.335 | 0.328 | 0.002 | 0.005 |
| 65° | 0.326 | 0.332 | 0.007 | 0.001 | 0.338 | 0.335 | 0.005 | 0.002 |

TABLE 6
CIE x, y color coordinates and color shifts - Example 4

| Incident | | | | | | | | |
|---|---|---|---|---|---|---|---|---|
| Angle | xᵣ | yᵣ | Δxᵣ | Δyᵣ | xₜ | yₜ | Δxₜ | Δyₜ |
| 48° | 0.324 | 0.335 | 0.009 | 0.002 | 0.334 | 0.334 | 0.001 | 0.001 |
| 52° | 0.331 | 0.336 | 0.002 | 0.003 | 0.333 | 0.334 | 0.000 | 0.001 |
| 56° | 0.332 | 0.335 | 0.001 | 0.002 | 0.333 | 0.334 | 0.000 | 0.001 |
| 60° | 0.330 | 0.335 | 0.003 | 0.002 | 0.334 | 0.334 | 0.001 | 0.001 |
| 64 | 0.329 | 0.334 | 0.004 | 0.004 | 0.334 | 0.334 | 0.001 | 0.001 |
| 68° | 0.337 | 0.330 | 0.004 | 0.003 | 0.333 | 0.334 | 0.000 | 0.001 |

TABLE 7
CIE x, y color coordinates and color shifts - Example 5

| Incident | | | | | | | | |
|---|---|---|---|---|---|---|---|---|
| Angle | xᵣ | yᵣ | Δxᵣ | Δyᵣ | xₜ | yₜ | Δxₜ | Δyₜ |
| 15° | 0.337 | 0.339 | 0.004 | 0.006 | 0.333 | 0.333 | 0.000 | 0.000 |
| 20° | 0.335 | 0.328 | 0.002 | 0.005 | 0.333 | 0.335 | 0.000 | 0.002 |
| 25° | 0.333 | 0.328 | 0.000 | 0.005 | 0.333 | 0.335 | 0.000 | 0.002 |
| 30° | 0.331 | 0.331 | 0.002 | 0.002 | 0.334 | 0.334 | 0.001 | 0.001 |
| 35° | 0.336 | 0.329 | 0.003 | 0.004 | 0.333 | 0.335 | 0.000 | 0.002 |
| 40° | 0.327 | 0.333 | 0.006 | 0.000 | 0.335 | 0.334 | 0.002 | 0.001 |

As can be seen all beam splitters according to Examples 1 to 5 result-after transmitting or reflecting an incident light beam-in very low color shifts over a wide range od incident angles. Moreover, as can be seen in Table 2, all beam splitters show low phase shifts at specific incident angles.

### BRIEF DESCRIPTION OF THE DRAWINGS

Various aspects of this invention will become apparent to those skilled in the art from the following detailed description of preferred embodiments, when read in light of the accompanying schematic drawings, wherein

FIG. 1a shows a schematic drawing of one embodiment of a beam splitter according to the invention including further illustrations;

FIG. 1b shows a schematic drawing of a reference substrate under otherwise identical conditions as shown in FIG. 1a;

FIG. 2 a schematic illustration of a stack according to the second aspect of the invention;

FIG. 3 a flowchart of a method according to the third aspect of the invention; and

FIG. 4a, 4b are CIE 1931 xy chromaticity diagrams illustrating the color shift of a light beam after being transmitted through (FIG. 4a) or reflected by (FIG. 4b) the beam splitter according to Example 1.

### DETAILED DESCRIPTION OF THE INVENTION

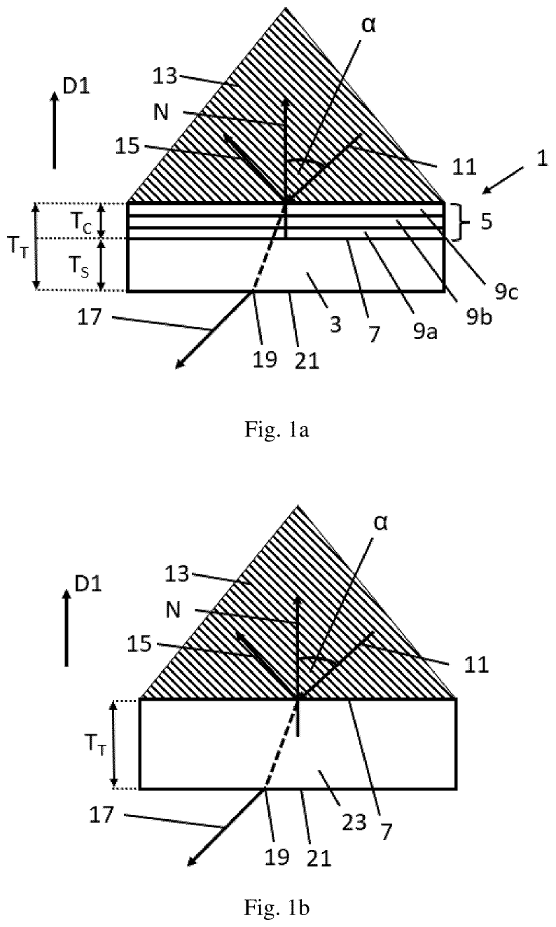

FIG. 1a shows a beam splitter 1 which comprises a substrate 3 made of glass and a coating 5 which is applied on a first main surface 7 of the substrate 3. The coating 5 has three layers 9a, 9b and 9c which are made of different materials.

The refractive index of the coating 5 is adjusted in a precise manner by combining the three layers 9a, 9b and 9c having different refractive indexes to achieve a target refractive index of the coating. For example, layer 9a may have a low refractive index of 1.5 and layer 9b may have a high refractive index of 2.2 while layer 9c may have a refractive index of 1.7 so that the refractive index of the coating 5 may be 1.61. The layer 9a or the layer 9c may be a matching layer which matches the refractive index of the substrate material of 1.61. By combining the different layers, the reflectivity and transmittivity as well as the resulting color shift of the beam splitter can be defined by means of the other layers and at the same time the phase of an incident light beam can be controlled (especially via the matching layer).

The substrate 3 has a thickness of TS along a first direction D1 which is parallel to the normal vector N of the first main surface 7 (and likewise parallel to the, in FIG. 1a not shown, normal vector of the coating 5). And the coating 5 has a thickness of TC along the first direction D1. The total thickness of the beam splitter 1 along the first direction D1 is TT, which is the sum of TC and TS. In FIG. 1a a specific light beam 11 which is incident on the beam splitter 1 is shown. The specific light beam has a has a chromaticity x, y according to CIE. The direction of the specific light beam is illustrated by means of an arrow. The angle of incident (also referred as “incident angle”), which is the angle α between a vector parallel to the first direction D1, such as the normal vector N of the first main surface 7, and a vector parallel to the specific light beam 11 is e.g. 30°. The specific wavelength of the specific light beam 11 is 550 nm. Actually, the specific light beam propagates within a prism 13 which is closely attached to the beam splitter 1. The prism 13 works as coupling element so that the specific light beam 11 can be coupled into the beam splitter 1.

A portion of the specific light beam 11 is reflected by the beam splitter 1 so that a reflected partial light beam 15 (“also referred as “reflected light beam”) is created. The reflected light beam has a chromaticity x, y according to CIE. Another portion of the specific light beam 11 is transmitted through the beam splitter 1 so that a transmitted partial light beam 17 (also referred as “transmitted light beam”) is created, wherein the transmitted light beam has a chromaticity x, y according to CIE.

An illustration of the propagation path of the specific light beam 11 within the beam splitter 1, i.e. within the coating 5 and the substrate 3, is shown as a dashed line.

The transmitted portion of the specific light beam 11, i.e. partial light beam 17, leaves the beam splitter 1 at an exit point 19 which is on the second main surface 21 of substrate 3 and which second main surface 21 points in an opposite direction than the first main surface 7.

FIG. 1b shows an identical setup as that shown in FIG. 1a, wherein same features are labeled with same reference signs. However, the beam splitter 1 has been replaced by a reference substrate 23 which is identical to substrate 3 but has a thickness of TT along the first direction D1. In other words, the reference substrate 23 has a thickness which is identical to the total thickness of the beam splitter 1 of FIG. 1a.

If the phase of the transmitted partial light beam 17 in FIG. 1a is compared to the phase of the transmitted partial light beam 17 in FIG. 1b, (in both scenarios at the respective exit point 19) then there can be evaluated a phase difference which has an absolute value of less than 30°.

This allows to use the beam splitter 1 preferably in augmented reality applications because the phase difference can be limited and reflectivity/transmittivity can also be defined as described above.

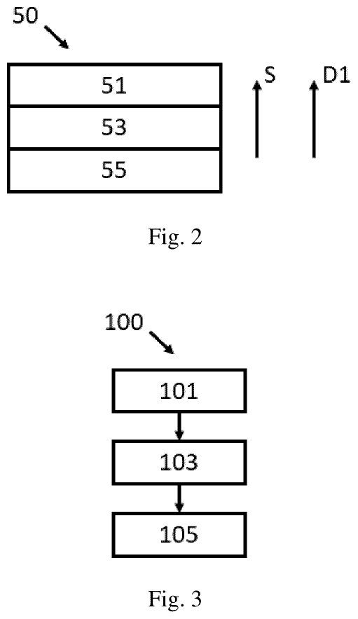

FIG. 2 shows a stack 50 according to the second aspect of the invention. Stack 50 comprises three beam splitters 51, 53 and 55 according to the first aspect of the invention. The beam splitters 51, 53 and 55 might at least partly or entirely be realized in form of the beam splitter 1 described above with reference to FIGS. 1a and 1b.

The beam splitters 51, 53 and 55 are arranged one above the other along a stacking direction S, wherein the stacking direction is parallel to the first direction D1.

FIG. 3 shows a flowchart 100 of a method according to the third aspect of the invention.

In 101 a substrate (e.g. substrate 1) is provided. In 103 a coating (e.g. coating 5) is arranged on one of the main surfaces (e.g. first main surface 7) of the substrate. In 105 a beam splitter according to the first aspect of the invention (e.g. beam splitter 1) is obtained.

The features disclosed in the description, the figures as well as the claims could be essential alone or in every combination for the realization of the invention in its different embodiments.

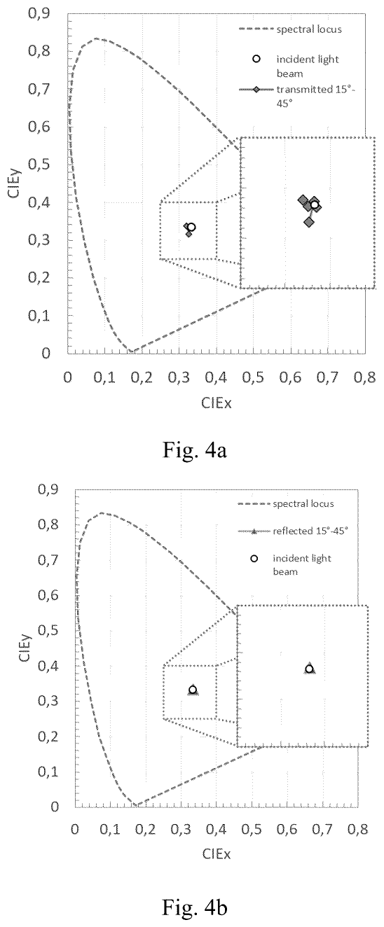

FIG. 4a and FIG. 4b show CIE 1931 xy color diagrams illustrating the color shift of an incident light beam (also referred as “specific light beam”) after being transmitted through (FIG. 4a) and reflected by (FIG. 4b) a beam splitter (also referred as “partial transmitted light beam” or “transmitted light beam” and “reflected partial light beam” or “reflected light beam”) according to Example 1. FIG. 4a shows the location of the incident light beam (circle) having a chromaticity according to CIE x,y of 0.333; 0.333 and—depending of the incident angle of the specific light beam—the resulting chromaticity of the transmitted light beam (rhombs). FIG. 4b shows the location of the incident light beam (circle) having a chromaticity according to CIE x,y of 0.333; 0.333 and—depending of the incident angle of the specific light beam—the resulting chromaticity of the reflected light beam (triangles).

### LIST OF REFERENCE NUMERALS

1 Beam splitter
3 Substrate
5 Coating
7 First main surface
9a, 9b, 9c Layer
11 Specific light beam
13 Prism
15 Reflected partial light beam
17 Transmitted partial light beam
19 Exit point
21 Second main surface
23 Reference Substrate
50 Stack
51 Beam splitter
53 Beam splitter
55 Beam splitter
100 Flowchart
101 Providing a substrate
103 Arranging a coating on the substrate
105 Obtaining a beam splitter
α (Incident) Angle
D1 First direction
N Normal vector
S Stacking direction
TC Thickness
TS Thickness
TT Thickness

1. A partial beam splitter comprising a substrate made of a substrate material and a coating arranged on a main surface of the substrate, wherein along a first direction which is parallel to the normal vector of the main surface, the substrate and all coatings have a total thickness, and
wherein for a specific light beam having a specific chromaticity defined by CIE x and y, which is incident on the beam splitter along a second direction with an incident angle in the range from 15° to 75° enclosed between a vector pointing in said first direction and a vector pointing in said second direction, and which is partly transmitted through the beam splitter and partly reflected by the beam splitter, said light beam after transmitting through the beam splitter has a difference between the CIE x coordinates of the specific light beam and the CIE x coordinates of the light beam after transmitting through the beam splitter is less than 0.05 and/or
a difference between the CIE y coordinates of the specific light beam and the CIE y coordinates of the light beam after transmitting through the beam splitter is less than 0.05.

2. The beam splitter according to claim 1, wherein the coating has a refractive index n_{c} corresponding to the refractive index of the substrate nₛ, or the ratio of the refractive index of the coating (n_{c}) and the refractive index of the substrate (nₛ) at a specific wavelength is between 0.95 and 1.05 and/or
wherein an absolute value of the difference of the refractive index of the substrate (nₛ) and the refractive index of the coating (n_{c}) is 1.00 or less and/or is 0.0001.

3. The beam splitter according to claim 1, wherein the beam splitter has a wavelength dependent transmittance and a wavelength dependent reflectance,
wherein for a specific incident angle, and/or at an incident angle of 30°, the beam splitter has a maximum transmittance T₍₄₂₀₋₆₈₀₎ₘₐₓ and a minimum transmittance T₍₄₂₀₋₆₈₀₎ₘᵢₙ in a wavelength range of from 420 nm to 680 nm, and wherein the difference between T₍₄₂₀₋₆₈₀₎ₘₐₓ and T₍₄₂₀₋₆₈₀₎ₘᵢₙ is less than 10% and/or
wherein the beam splitter has a maximum reflectance R₍₄₂₀₋₆₈₀₎ₘₐₓ and a minimum reflectance R₍₄₂₀₋₆₈₀₎ₘᵢₙ in a wavelength range of from 420 nm to 680 nm, wherein the difference between R₍₄₂₀₋₆₈₀₎ₘₐₓ and R₍₄₂₀₋₆₈₀₎ₘᵢₙ is less than 10% and/or
the beam splitter has a maximum transmittance T₍₄₃₀₎ₘₐₓ and a minimum transmittance T₍₄₃₀₎ₘᵢₙ at 430 nm and wherein the difference between T₍₄₃₀₎ₘₐₓ and T₍₄₃₀₎ₘᵢₙ is less than 10% and/or
the beam splitter has a maximum reflectance R₍₄₃₀₎ₘₐₓ and a minimum reflectance R₍₄₃₀₎ₘᵢₙ at 430 nm, wherein the difference between R₍₄₃₀₎ₘₐₓ and R₍₄₃₀₎ₘᵢₙ is less than 10%, and/or
the beam splitter has a maximum transmittance T₍₅₃₅₎ₘₐₓ and a minimum transmittance T₍₅₃₅₎ₘᵢₙ at 535 nm, wherein the difference between T₍₅₃₅₎ₘₐₓ and T₍₅₃₅₎ₘᵢₙ is less than 10%, and/or
the beam splitter has a maximum reflectance R₍₅₃₅₎ₘₐₓ and a minimum reflectance R₍₅₃₅₎ₘᵢₙ at 535 nm, wherein the difference between R₍₅₃₅₎ₘₐₓ and R₍₅₃₅₎ₘᵢₙ is less than 10%, and/or
the beam splitter has a maximum transmittance T₍₅₆₅₎ₘₐₓ and a minimum transmittance T₍₅₆₅₎ₘᵢₙ at 565 nm, wherein the difference between T₍₅₆₅₎ₘₐₓ and T₍₅₆₅₎ₘᵢₙ is less than 10%, and/or
the beam splitter has a maximum reflectance R₍₅₆₅₎ₘₐₓ and a minimum reflectance R₍₅₆₅₎ₘᵢₙ at 565 nm, wherein the difference between R₍₅₆₅₎ₘₐₓ and R₍₅₆₅₎ₘᵢₙ is less than 10%.

4. The beam splitter according to claim 1, wherein the difference between the CIE x coordinates of the specific light beam and the CIE x coordinates of the reflected light beam is less than 0.05 and/or
the difference between the CIE y coordinates of the specific light beam and the CIE y coordinates of the reflected light beam is less than 0.05.

5. The beam splitter according to claim 1, wherein the specific light beam has a chromaticity according to CIE of x in the range from 0.283 to 0.383 and/or a chromaticity according to CIE of y in the range from 0.283 to 0.383.

6. The beam splitter according to claim 1, wherein for light having a specific wavelength within the range of 450 nm and 650 nm which is incident on the beam splitter along a second direction with an incident angle of 30° enclosed between a vector pointing in said first direction and a vector pointing in said second direction, said specific light beam after transmitting through the beam splitter has a phase having a phase difference of an absolute value of less than or equal to 30° compared to the case in which, under otherwise identical conditions, the beam splitter is replaced by a reference substrate made of the substrate material and having a thickness identical to the total thickness of the beam splitter.

7. The beam splitter according to claim 6, wherein the phase difference has an absolute value which is less than or equal to 20°, and/or is greater than or equal to 0.5°.

8. The beam splitter according to claim 1, wherein the coating has at least two layers and/or between 1 and 5000 layers.

9. The beam splitter according to claim 1, wherein a thickness of each layer of the coating along the first direction
is greater than or equal to 1 nm; and/or
is less than or equal to 5000 nm; and/or
is between 1 nm and 5000 nm.

10. The beam splitter claim 1, wherein a layer of the coating is a dielectric layer, and/or a layer of the coating having a thickness along the first direction of 10 nm or less, comprises metal, and/or the coating has no layers made of and/or comprising metal.

11. The beam splitter claim 1, wherein the coating has a spatially variable index layer or is made of one single spatially variable index layer.

12. The beam splitter claim 1, wherein the coating is at least partially applied to the substrate by physical vapor deposition (PVD).

13. The beam splitter claim 1, wherein a layer of the coating constitutes a matching layer, and wherein optionally
(i) the matching layer has a refractive index and/or an optical dispersion corresponding to the refractive index and/or the dispersion pattern, respectively, of the substrate,
(ii) the ratio of the refractive index of the matching layer and the refractive index of the substrate is between 0.95 and 1.05,
(iii) the matching layer has a thickness of between 15 nm and 750 nm,
(iv) the matching layer is arranged directly on the substrate and/or as an adhesive layer,
(v) two or more layers of the coating each constitute a matching layer, and/or
(vi) the total thickness of all matching layers of the coating is greater than the thickness of each of the other layers of the coating
(vii) the total thickness of all matching layers of the coating is in the range from 250 nm to 1750 nm.

14. The beam splitter claim 1, wherein the matching layer comprises
a. one or more components selected from one or more oxides, one or more fluorides, one or more nitrides, one or more sulfides, one or more selenides, one or more metals, and combinations of two or more thereof; and/or
b. one or more components selected from one or more metal oxides, one or more metal fluorides, one or more metal nitrides, one or more metal sulfides, one or more metal selenides and combinations of two or more thereof.

15. The beam splitter according to claim 13, wherein
a. the oxide is selected from silicon oxide, aluminum oxide, hafnium oxide, tantalum oxide, niobium oxide, titanium oxide, zirconium oxide, yttrium oxide, praseodymium oxide, scandium oxide, tin oxide, chromium oxide, indium oxide and combinations of two or more thereof;
b. the fluoride is selected from aluminum fluoride, magnesium fluoride, neodymium fluoride, lanthanum fluoride, yttrium fluoride, gadolinium fluoride, ytterbium fluoride and combinations of two or more thereof;
c. the nitride is selected from aluminum nitride, silicon nitrides and combinations thereof;
d. the sulfide is zinc sulfide;
e. the selenide is zinc selenide; and/or
f. the metal is selected from aluminum, silver, gold, chromium, nickel and combinations thereof.

16. The beam splitter claim 1, wherein a thickness of the coating along the first direction is greater than or equal to 500 nm; and/or
is less than or equal to 3000 nm; and/or
is between 500 nm and 3000 nm.

17. The beam splitter claim 1, wherein a refractive index of the coating is 1.45 or greater; and/or is 3.00 or less.

18. The beam splitter claim 1, wherein a thickness of the substrate along the first direction is greater than or equal to 0.1 mm; and/or
is less than or equal to 20.0 mm; and/or
is between 0.1 mm and 20.0 mm.

19. The beam splitter claim 1, wherein a refractive index of the substrate is 1.45 or greater; and/or is 3.00 or less.

20. The beam splitter claim 1, wherein the substrate is essentially cuboidal.

21. The beam splitter claim 1, wherein the substrate comprises glass, and/or untempered glass.

22. The beam splitter claim 1, wherein a coating is arranged on each of the two main surfaces of the substrate, wherein optionally the two coatings are identical.

23. The beam splitter claim 1, wherein the coating has a reflectance of at least 0.03 and/or at most 0.35, a transmittance of at least 0.65 and/or at most 0.97, and/or
an absorbance of at least 0.001 and/or at most 0.01, in particular for light of the specific wavelength incident on the partial beam splitter, and/or for a value for the refractive index of ne.

24. A stack comprising two or more beam splitters claim 1, wherein optionally the beam splitters are arranged one above the other along a stacking direction.

25. The stack according to claim 24, wherein the beam splitters following one another along the stacking direction or along a direction antiparallel to the stacking direction have a different reflectivity and/or a different transmittivity for the portion of the specific light beam incident on them respectively.

26. The stack according to claim 24, wherein the specific light beam is guided and/or can be guided along the beam splitters within the stack.

27. A method of manufacturing a beam splitter, comprising providing a substrate and arranging a coating on a main surface of the substrate so as to obtain a beam splitter according to claim 1.
